(19) United States
(12) Patent Application Publication
(10) Pub. No.: US 2016/0167275 A1
(43) Pub. Date: Jun. 16, 2016

(54) DEVICE FOR REWORKING AN INJECTION-MOLDED COMPONENT AND ARRANGEMENT WITH MULTIPLE DEVICES

(71) Applicant: FINKE FORMENBAU GMBH, ALTENBEKEN-BUKE (DE)

(72) Inventors: MARKUS FINKE, ALTENBEKEN-SCHWANEY (DE); HARTWIG FELDMANN, SCHLANGEN (DE); ANDREAS BÖLTE, ALTENBEKEN-SCHWANEY (DE)

(21) Appl. No.: 14/967,413

(22) Filed: Dec. 14, 2015

(30) Foreign Application Priority Data
Dec. 15, 2014 (DE) 20 2014 106 045.6

(51) Int. Cl. B29C 45/38

(52) U.S. Cl. CPC B29C 45/382

(57) ABSTRACT

A device for reworking an injection-molded component that features a support component, on which an injection-molded component is supported for the reworking operation in the region of a supporting surface and a separating tool for separating one or more sprue sections on the injection-molded component positioned on the support component, wherein the separating tool is realized with a cutting tool, in which one cutting edge is arranged on the support component and an additional cutting edge assigned to said cutting edge is arranged on a displaceable component that can be displaced relative to the support component and the cutting edge arranged thereon together with the additional cutting edge, namely in such a way that one or more sprue sections can be separated by means of the cutting edge and the additional cutting edge is provided. In addition, an arrangement with multiple devices for reworking an injection-molded component is proposed.

### CROSS-REFERENCE TO RELATED APPLICATIONS

This application claims priority to German Application No. 20 2014 106 045.6 having a filing date of Dec. 15, 2014, the entire contents of which are hereby incorporated by reference.

### FIELD OF TECHNOLOGY

The following refers to a device for reworking an injection-molded component and to an arrangement with multiple devices.

### BACKGROUND

Devices of this type are used for reworking previously produced injection-molded components, particularly for separating sprue sections created during the injection molding process. For this purpose, conventional devices are provided with separating tools that are realized in the form of a cutting tool and respectively clamped on a tool holder. The produced injection-molded component is in conventional devices placed onto support elements in order to carry out the reworking operation. The support elements are distributed over a carrier plate of the device in order to ensure a distributed support of the injection-molded components. Tool holders are provided on the carrier plate separately of and in addition to the support elements in order to hold and clamp the cutting tools. Once the previously produced injection-molded component has been placed onto the support elements, the sprue sections are cut off by means of the cutting tools.

However, quality problems arise with conventional cutting devices, in particular, due to the fact that remnants consistently remain on the injection-molded components during the separation of the sprue sections such that objectionable protrusions are created on the injection-molded components.

Document DE 103 02 751 B4 discloses a method for removing a sprue from a casting, particularly a crank case of an internal combustion engine.

Document DE 10 2009 027 996 A1 discloses a method and a device for cutting or separating a workpiece, particularly for separating a sprue from a workpiece, wherein the workpiece is placed into a workpiece holder and a cutting or separating tool is moved toward the workpiece by means of an actuating drive and then activated.

Document DE 696 22 224 T2 discloses a method and a device for removing sprue sections.

### SUMMARY

An aspect relates to an improved device for reworking an injection-molded component, as well as an arrangement with multiple devices, in which the disadvantages of the prior art are eliminated. It should be possible, in particular, to separate the sprue sections on the injection-molded component in an exact and quality-assuring fashion.

According to one aspect, a device for reworking an injection-molded component is provided, wherein said device features a support component, on which an injection-molded component is supported for the reworking operation in the region of a supporting surface. The device furthermore features a separating tool that is designed for separating one or more sprue sections on the injection-molded component positioned on the support component. The separating tool is realized with a cutting tool, in which one cutting edge is arranged on the support component and an additional cutting edge assigned to said cutting edge is arranged on a displaceable component that can be displaced relative to the support component and the cutting edge arranged thereon together with the additional cutting edge, namely in such a way that one or more sprue sections can be separated by means of the cutting edge and the additional cutting edge. The two cutting edges are moved toward and apart from one another by displacing the displaceable component accordingly.

According to another aspect, an arrangement with multiple devices for reworking an injection-molded component is provided, wherein the multiple devices are designed for respectively accommodating a section of an injection-molded component to be reworked and for separating one or more associated sprue sections from an injection-molded component supported thereon. The multiple devices form a distributed arrangement of supporting surfaces for accommodating the injection-molded component to be processed. Some or all of the multiple devices may be mounted on a carrier plate such as, for example, a metal plate. Each of the devices features a cutting tool in order to separate one or more sprue sections from the injection-molded component supported therein.

The cutting edge may be arranged on the support component in a stationary fashion. In this context, a stationary arrangement refers to the cutting edge remaining stationary and only the additional cutting edge moving toward said cutting edge while a cutting operation is carried out. For example, the cutting edge may be screwed on the support component. The cutting edge can be separably mounted by means of such a screw connection or a different type of connection. The position of the cutting edge on the support component may be adjustable, for example, by loosening the screw connection and subsequently displacing the cutting edge on the support component.

The cutting edge may be separably mounted on the support component. In this respect, the cutting edge may be realized on a replaceable or exchangeable component that is simply screwed on the support component. The additional cutting edge may be alternatively or additionally mounted on the displaceable component in a separable and/or adjustable fashion.

The cutting edge may be realized on the support component in the form of a stopping face, against which the additional cutting edge is guided during the cutting operation, if applicable, until it contacts the stopping face. In this embodiment, the sprue sections are separated by being nipped off.

The support component may comprise an outer recess adjacent to the cutting edge, wherein this recess is designed for at least partially accommodating the additional cutting edge and/or a section of the displaceable component when the additional cutting edge is displaced into a closed position toward the cutting edge. During the transition into the closed position, which may also be referred to as cutting position, the additional cutting edge and/or a section of the displaceable component are displaced into the recess in the support component.

The displaceable component may be arranged on the support component. In this embodiment, the displaceable component with the additional cutting edge is mounted on the support component.

The displaceable component may be pivotable. The displaceable component may alternatively carry out a linear motion during the separating operation. A combination of a pivoting motion and a linear action may also be carried out.

The displaceable component may be functionally coupled to a drive unit that is designed for displacing the displaceable component with the additional cutting edge arranged thereon between an open and the closed position. The drive unit may consist of an electric, pneumatic or hydraulic drive unit. A combination of different drive mechanisms may also be provided. In one embodiment, the drive unit is at least partially realized in the support component. If a pneumatic or hydraulic drive unit is used, for example, the corresponding flow channels therefore can extend in the support component.

The support component may be composed of several parts. As an alternative to such a multipart design, the support component may also be realized in one piece. If a multipart design is used, elements of the support component may be separably or inseparably connected to one another. For example, the supporting surface and/or the cutting edge may be arranged on a separably mounted component.

The support component may feature a base component and a support element arranged thereon, wherein the support component is supported on said support element in the region of the supporting surface. The support element may be separably mounted on the base component, for example, by means of a screw connection and/or a plug connection. The base component may be realized in the form of a mounting block. The recess, into which the additional cutting edge and/or a section of the displaceable component can be inserted during the displacement into the closed position, may be arranged on the base component and/or the support element. The drive unit may be partially or completely integrated into the base component.

The displaceable component may be arranged on the support element. The displaceable component may be alternatively arranged on the base component. The displaceable component may furthermore be mounted on the base component as well as on the support element.

The supporting surface may have a three-dimensional surface contour that is designed for accommodating an assigned section of the injection-molded component in a form-fitting fashion. In this way, surface contact between the assigned section of the injection-molded component and the supporting surface is produced.

The device for reworking an injection-molded component may be provided with a clamping device, by means of which an injection-molded component is secured in the supported position, particularly during the separation of the sprue sections.

The proposed device makes it possible to implement a method for reworking an injection-molded component, in which a previously produced injection-molded component is placed and supported on a support component for the reworking operation. After the injection-molded component has been optionally clamped on the support component, one or more sprue sections on the supported injection-molded component are separated with the aid of a separating tool. The separating tool is realized in the form of a cutting tool, in which one cutting edge is arranged on the support component and an additional cutting edge assigned to said cutting edge is arranged on a displaceable component, wherein the displaceable component is displaced relative to the support component and the cutting edge arranged thereon during the separation of the sprue sections.

### BRIEF DESCRIPTION

Some of the embodiments will be described in detail, with reference to the following figures, wherein like designations denote like members, wherein:

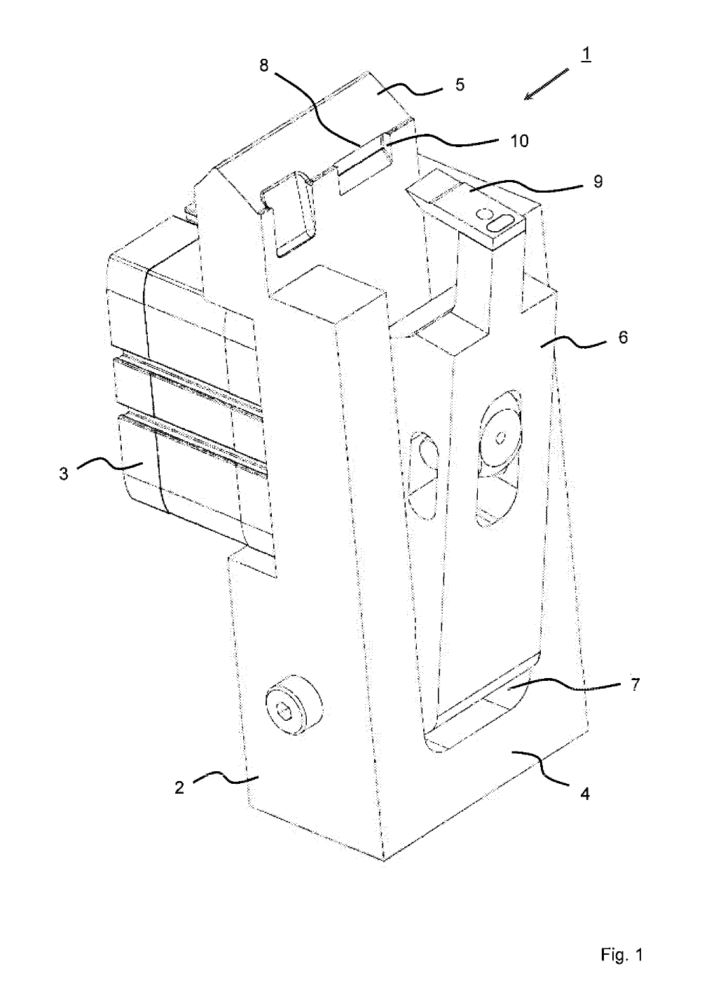

FIG. 1 shows a perspective view of a device for reworking an injection-molded component, in which a cutting tool is illustrated in an open position,

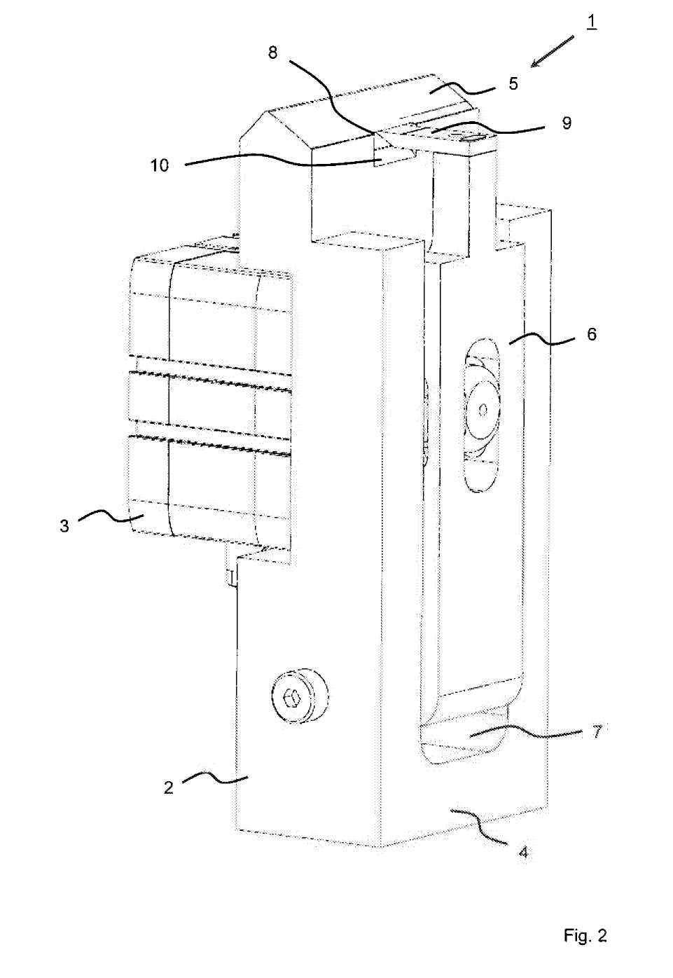

FIG. 2 shows a perspective view of the device according to FIG. 1, in which the cutting tool is illustrated in the closed position,

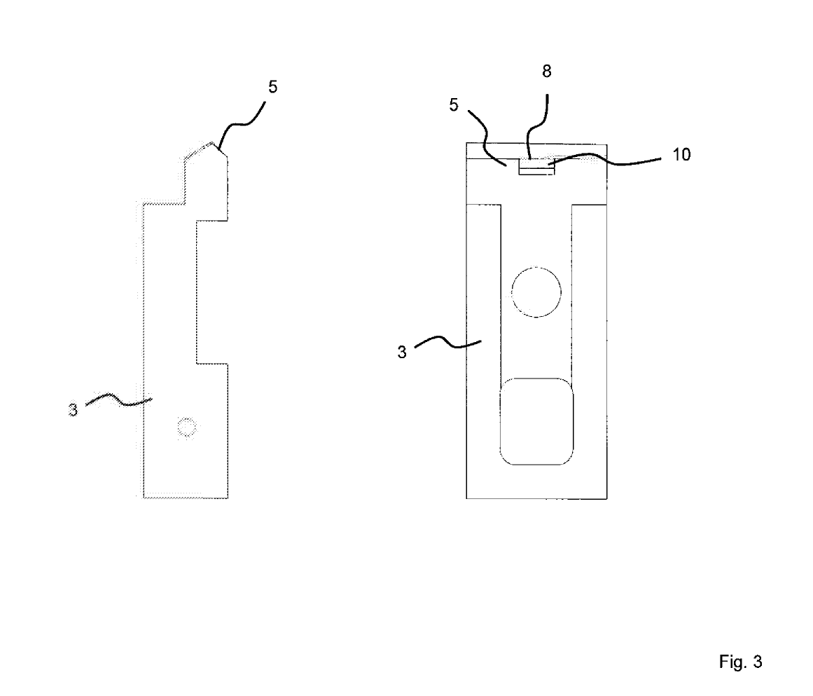

FIG. 3 shows a side view and a front view of the support element of the device according to FIG. 1,

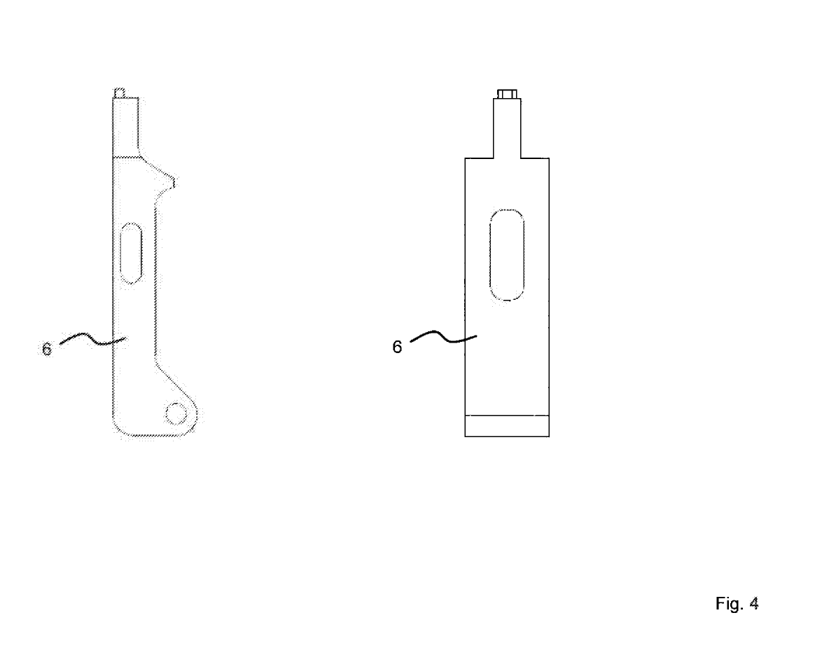

FIG. 4 shows a side view and a front view of a displaceable component of the device according to FIG. 1 which is realized in the form of a lever arm, and

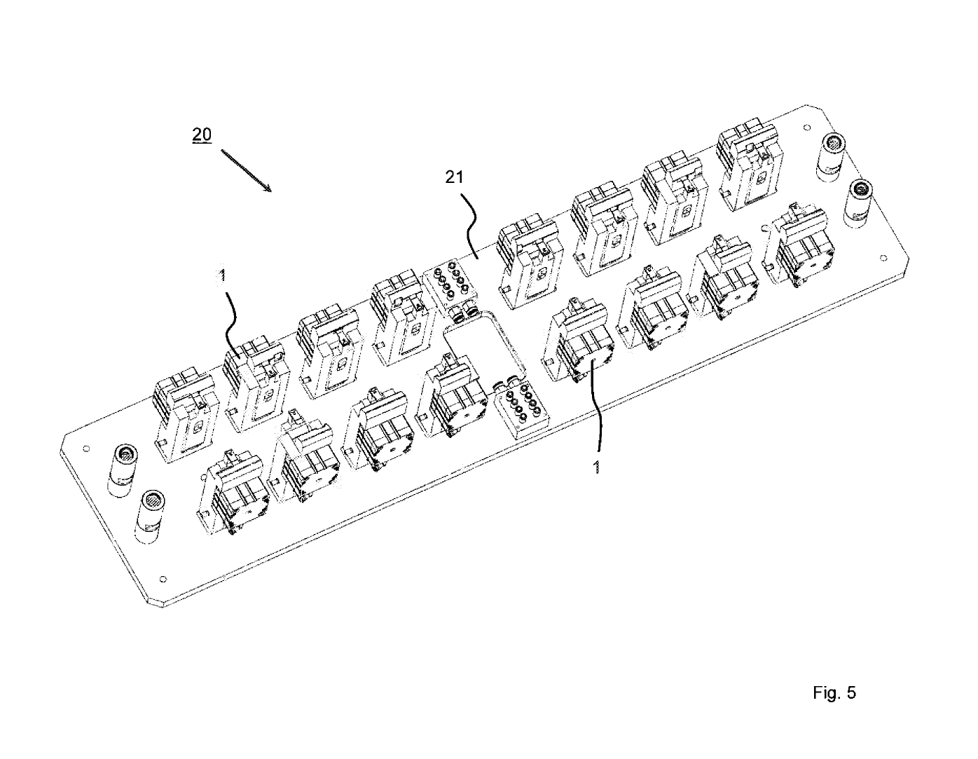

FIG. 5 shows a perspective view of a cutting device with multiple devices for reworking an injection-molded component.

### DETAILED DESCRIPTION

A device for reworking an injection-molded component is described below with reference to FIGS. 1 to 4.

FIGS. 1 and 2 show perspective views of a device 1 for reworking an injection-molded component, wherein a cutting tool is respectively illustrated in an open and a closed position. The device 1 features a support component 2 that in the embodiment shown has a multipart design with a base component 3 and a support element 4 mounted thereon. The support element 4 features a supporting surface 5 with a three-dimensional surface contour that is adapted to the surface contour of the (not-shown) injection-molded component to be processed in such a way that a section of the injection-molded component is supported in a form-fitting fashion in the region of the supporting surface 5.

In the embodiment shown, the base component 2 is realized in the form of a mounting block, on which different components can be flexibly mounted.

A displaceable component 6 in the form of a lever arm is arranged on the support element 4 in a mounting recess 7 in such a way that the displaceable component 6 can be displaced between an open position that is illustrated in FIG. 1 and a closed position that is illustrated in FIG. 2 and can also be referred to as cutting or shearing position. This displacement between the closed and the open position is realized in that the displaceable component 6 is coupled to a (not-shown) drive unit that may consist, for example, of an electric, hydraulic or pneumatic drive unit. If a pneumatic drive unit is used, flow channels for transmitting the air flow may extend in the base component 3. The drive unit may be completely or partially integrated into the base component 3. For example, the base component 3 may be realized with a pneumatic or hydraulic cylinder.

A cutting edge 8 is realized on the support element 4 and cooperates with an additional cutting edge 9 that in turn is mounted on the displaceable component 6, for example, by means of a screw connection. In the closed position illustrated in FIG. 2, the separation of the sprue section on the supported injection-molded component is achieved due to the cooperation between the cutting edge 8 and the additional cutting edge 9. In this case, the additional cutting edge 9 engages into a recess 10 formed in the support element 4 in the closed position.

FIGS. 3 and 4 respectively show side views and front views of the support element 4 and of the displaceable component 6.

FIG. 5 shows a perspective view of an arrangement with multiple devices 20, in which multiple cutting devices realized in accordance with the device 1 in FIGS. 1 to 4 are arranged on a carrier plate 21. The multiple devices provide supporting surfaces 5 that are distributed over the carrier plate 21 and on which the injection-molded component to be processed is supported. The respective cutting device can be used for locally separating one or more sprue sections.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A device for reworking an injection-molded component, comprising
a support component, on which an injection-molded component is supported for the reworking operation in the region of a supporting surface, and
a separating tool that is designed for separating one or more sprue sections on the injection-molded component positioned on the support component,
wherein the separating tool comprises a cutting tool, in which one cutting edge (8) is arranged on the support component and an additional cutting edge assigned to said cutting edge is arranged on a displaceable component that can be displaced relative to the support component and the cutting edge arranged thereon together with the additional cutting edge, namely in such a way that one or more sprue sections can be separated by means of the cutting edge and the additional cutting edge.

2. The device according to claim 1, wherein the cutting edge is arranged on the support component in a stationary fashion.

3. The device according to claim 1, wherein the cutting edge is separably mounted on the support component.

4. The device according to claim 1, wherein the support component comprises an outer recess adjacent to the cutting edge, wherein this recess is designed for at least partially accommodating the additional cutting edge and/or a section of the displaceable component when the additional cutting edge is displaced into a closed position toward the cutting edge.

5. The device according to claim 1, wherein the displaceable component is arranged on the support component.

6. The device according to claim 1, wherein the displaceable component is pivotable.

7. The device according to claim 1, wherein the displaceable component is functionally coupled to a drive unit that is designed for displacing the displaceable component with the additional cutting edge arranged thereon between an open and the closed position.

8. The device according to claim 1, wherein the support component is composed of several parts.

9. The device according to claim 8, wherein the support component comprises a base component and a support element arranged thereon, wherein the support component is supported on said support element in the region of the supporting surface.

10. The device according to claim 9, wherein the displaceable component is arranged on the support element.

11. The device according to claim 1, wherein the supporting surface has a three-dimensional surface contour that is designed for accommodating an assigned section of the injection-molded component in a form-fitting fashion.

12. An arrangement with multiple devices for reworking an injection-molded component according to claim 1, wherein the multiple devices are designed for respectively accommodating a section of an injection-molded component to be reworked and for separating an associated sprue section from an injection-molded component supported thereon.
